(19) United States
(12) Patent Application Publication
(10) Pub. No.: US 2025/0031701 A1
(43) Pub. Date: Jan. 30, 2025

(54) Herbicidal Compositions

(71) Applicant: Syngenta Crop Protection AG, Basel (CH)

(72) Inventors: Philip LAMERS, Munchwilen (CH); Claudia SIEBOLD, Mucnchwilen (CH)

(73) Assignee: Syngenta Crop Protection AG, Basel (CH)

(21) Appl. No.: 18/716,748

(22) PCT Filed: Dec. 1, 2022
(86) PCT No.: PCT/EP2022/084027

§ 371 Date: Jun. 5, 2024

(30) Foreign Application Priority Data
Dec. 6, 2021 (GB) 2117597.1

(51) Int. Cl. A01N 43/90; A01N 25/04; A01N 25/32; A01P 13/02

(52) U.S. Cl. CPC A01N 43/90; A01N 25/04; A01N 25/32; A01P 13/02

(57) ABSTRACT

A liquid herbicidal composition comprising pinoxaden and an adjuvant; wherein the adjuvant is a built-in oil-type adjuvant.

The present invention relates to a liquid herbicidal composition, comprising pinoxaden, and a built-in oil-type adjuvant. The present invention also relates to methods for controlling and/or inhibiting the growth of weeds, such as monocotyledonous and/or dicotyledonous weeds, comprising applying to the weeds or to their locus a liquid herbicidal composition, comprising pinoxaden, and a built-in oil-type adjuvant.

Pinoxaden is a herbicide suitable for the control of grass weeds in certain cereals. Pinoxaden, due to the presence of the ester linkage, is extremely sensitive to pH, water, and salts and if the conditions are not appropriate be converted into the corresponding acid.

Many grass herbicides (graminicides) for cereals require an adjuvant to develop full biological activity. In many cases the physico-chemical properties of the active ingredients make it difficult to add an adjuvant to the composition. Either because the chemical or physical stability of the active ingredient suffers from the added adjuvant or because biological performance is insufficient. It is in particular very challenging to make a biologically efficient and stable composition due to the chemical and physical instability of the herbicides used.

In general, formulated pinoxaden products are always applied in combination with adjuvants which may be built-in or added to the spray tank (so-called tank-mix adjuvants). The application of pinoxaden and tank-mix adjuvants is problematic in that physical incompatibilities often exist which may lead to poor biological efficacy and/or problematic application of the admixtures. These incompatibilities also lead to increased levels of flocculation which can result in the blocking of application equipment.

Adjuvants may also be incorporated into the herbicide composition (so-called built-in adjuvants). The use of a built-in adjuvant provides the advantage of ensuring the correct dosage of the adjuvant is used in practice. If too little adjuvant is used, the full efficacy potential of the formulation is not achieved. If too high a dose of adjuvant is administered, however, there is the possibility of damage to the crop.

Compositions of pinoxaden comprising a built-in adjuvant are challenging to formulate due to both the instability of pinoxaden and the difficulties achieving physical compatibility between the built-in adjuvant and the rest of the formulation. To this date, formulations have relied upon tris(2-ethylhexyl) phosphate (TEHP).

Thus, there is need for a formulated composition comprising pinoxaden and a built-in adjuvant that demonstrates both a high degree of both chemical and physical stability, together with an improved technical performance.

In a first aspect of the invention, there is therefore provided a liquid herbicidal composition comprising pinoxaden, and an adjuvant; wherein the adjuvant is a built-in oil-type adjuvant.

Pinoxaden may be present at a percentage (%) of weight/volume of from 0.5 to 50% w/v, preferably from 0.75 to 30%, such as from 0.9 to 20%, from 1 to 15%, more preferably from 1 to 10%, or even from 2 to 7%.

The composition according to the present invention may contain a safener. Preferably, the safener is selected from cloquintocet, cloquintocet acid, cloquintocet-mexyl, mefenpyr-diethyl, cyprosulfamid, metcamifen, and isoxadifen-ethyl. These safeners are known and are described, for example, in The Pesticide Manual, 18th Ed., British Crop Protection Council 2018, or other readily available resources. In a preferred embodiment the safener is cloquintocet-mexyl or mefenpyr-diethyl.

The safener may be present at a percentage (%) of weight/volume of from 0.1 to 50% w/v, preferably from 0.5 to 20% w/v, more preferably from 1 to 10% w/v, and most preferably from 1.5 to 8% w/v.

The built-in high-performance oil-type adjuvant which has allowed a chemically and physically stable, active one-pack composition to be developed preferably comprises polypropylene glycol ethers, including polypropylene glycol stearyl ethers, polypropylene glycol butyl ethers, polypropylene glycol cetyl ethers, and polypropylene glycol myristyl ethers.

The polypropylene glycol ethers useful in the new composition are preferably polypropylene glycol stearyl ethers. Their structure is described below:

R—(O—CH₂CH(CH₃))ₙ—O—R₁

wherein R is a C12 to C18 straight- or branched-chain alkyl or alkenyl group, n is 1 to 30, and R₁ is H or methyl.

Preferably, R is a C14 to C18 straight- or branched-chain alkyl or alkenyl group, and more preferably R is a C16 to C18 straight- or branched-chain alkyl group.

Preferably n is 2 to 20; more preferably 5 to 18; and even more preferably 8 to 15. More preferably still, n is 11 or 15.

Preferably, R₁ is H.

Preferred polypropylene glycol stearyl ethers for use in the new compositions are stearyl ethers having between 10 and 20 polypropylene glycol units. Particularly preferred stearyl ethers include polypropylene-15-stearyl ethers and polypropylene-11-stearyl ethers. Polypropylene-15-stearyl ethers and polypropylene-11-stearyl ethers include Acconon® E (ABITEC), Arlamol™ PS15 (Croda Chem. Europe Ltd), Arlamol™ PS15E (Croda Inc), Finsolv® TPP (Innospec), Jeecol PSA-11 (Jeen International), Jeecol PSA-15 (Jeen International), Lipocol® P-15 (Lipo Chemicals), Lumisolve CSA-70 (Lambent Tech), Lumisolve CSA-75 (Lambent Tech), Procolm PSA-11 (Protameen), Procolm PSA-15 (Protameen), Sympatens ASP-150 (Kolb), Varonic® APS (Evonik), Witconol™ APS (Evonik), Finsolv® P (Innospec), and Prox-onic SA1-015/P (Protex International).

A particularly preferred polypropylene glycol stearyl ether is Arlamol™ PS15E, a stearyl ether having 11 polypropylene glycol units (Croda Chemicals Ltd. Goole, England).

The oil-type adjuvant may be present at a percentage (%) of weight/volume of from 1 to 50% w/v, preferably from 5 to 45% w/v, more preferably from 10 to 40% w/v.

Advantageously, the composition comprises no, or substantially no, tris(2-ethylhexyl) phosphate (TEHP). By ‘substantially no’ we mean less than 0.5% by weight.

Surfactants are included as emulsifiers, dispersants, and wetting agents. The surfactants useful in the new compositions are known in the art and comprise, for example, salts of alkyl sulfates, such as diethanolammonium lauryl sulfate; salts of arylsulfonates, such as calcium dodecyl-benzenesulfonate; alkylphenol-alkylene oxide addition products, such as nonylphenol ethoxylate; alcohol-alkylene oxide addition products, such as tridecyl alcohol ethoxylate; soaps, such as sodium stearate; salts of alkylnaphthalenesulfonates, such as sodium dibutylnaphthalenesulfonate; dialkyl esters of sulfosuccinate salts, such as sodium di(2-ethylhexyl)sulfosuccinate; sorbitol esters, such as ethoxylated sorbitol hexaoleate; quaternary amines, such as lauryl trimethylammonium chloride; polyethylene glycol esters of fatty acids, such as polyethylene glycol stearate; fatty alcohol alkoxylates which may be alkyl end-capped; block copolymers of ethylene oxide and propylene oxide; and salts of mono- and di-alkyl phosphate esters; alkylated polyvinylpyrrolidone, and also further substances described e.g. in “McCutcheon's Emulsifiers & Detergents”, North American Edition, MC Publishing Co., 2018. It is also possible to use a mixture of one or more of these surfactants.

Each surfactant may be present at a percentage (%) of weight/volume from 0.1 to 20%. Preferably from 0.5 to 10% w/v, more preferably from 0.75 to 8% w/v, and more preferably still from 1 to 6% w/v.

The total amount of surfactant may be comprised from 3 to 30% w/v, preferably from 5 to 25% w/v.

The new compositions may also comprise additional formulation aids known in the art such as crystallisation inhibitors, viscosity-modifying substances, suspending agents, dyes, anti-oxidants, foaming agents, light absorbers, mixing aids, anti-foams, complexing agents, neutralising or pH-modifying substances and buffers, corrosion-inhibitors, fragrances, wetting agents, absorption improvers, micronutrients, plasticisers, glidants, lubricants, dispersants, thickeners, anti-freezes, microbiocides, and also liquid and solid fertilisers.

Each additional formulation ingredient may be present at a percentage (%) of weight/volume of from 0.01% to 5% w/v.

Optionally, an additional co-herbicide may be incorporated into the compositions according to the present invention. It is preferred to select the co-herbicide from the group consisting of aryloxy- and heteroaryloxyphenoxy propionic acids, cyclohexandiones, sulfonyl urea, triazolopyrimidines, nitriles, thiocarbamates, dinitroanilines, benzoic acids, phenoxy acids and pyridine carboxylic acids. Of particular interest are fenquinotrione, clodinafop, tralkoxydim, prosulfocarb, triasulfuron, prosulfuron, amidosulfuron, iodosulfuron, chlorsulfuron, flupyrsulfuron, metsulfuron, sulfosulfuron, thifensulfuron, tribenuron, tritosulfuron, florasulam, metosulam, flumetsulam, pyroxsulam, 2,4-D, 2,4-DP, dichlorprop-p, MCPA, mecoprop, mecoprop-p, MCPB, clopyralid, bromoxynil, bromoxynil-octanoate, ioxynil, ioxynil-octanoate, fluroxypyr, trifluralin, diflufenican, picolinafen, pendimethalin and triallate, where tralkoxydim, triasulfuron, diflufenican, florasulam, pyroxsulam, pyroxsulam in combination with cloquintocet, clodinafop and clodinafop in combination with cloquintocet are preferred.

Preferably, the compositions according to the present invention are prepared in the form of an Emulsion Concentrate (EC) or an oil dispersion (OD).

However, it is also envisaged that the compositions according to the present invention may also be prepared in the form of a suspo-emulsion (SE) or suspension concentrate (SC). Such formulations are diluted prior to use. Diluted formulations can be prepared, for example, with water, liquid fertilisers, micronutrients, biological organisms, oil, or solvents.

Oil carriers can serve as a medium to disperse active ingredients. Oil carriers suitable for use in the composition of the present invention may be selected from rape seed oil, methylated rape seed oil, synthetic paraffins (e.g. (C12-C16), (C14-C18), (C15-C21), and (C18-C26)), dipropylene glycol dibenzoate, hydrocarbons (e.g. C11-C14, n-alkanes, isoalkanes, cyclics, and <2% aromatics), aromatic hydrocarbons (e.g. C10-C13, and <1% naphthalene), aromatic hydrocarbons (e.g. C9, and benzene<0.1%), mixtures of petroleum extracts comprising solvent-dewaxed light paraffinic and solvent-dewaxed heavy paraffinic distillates, solvent naphtha, citrate ester based solvents, tris (2-ethylhexyl) O-acetylcitrate, cyclohexanedicarboxylic acid, dinonyl ester, tri-n-hexyl-trimellitate, 1,2,4-benzenetricarboxylicacid, trihexylester, isopropyl myristate, decanedioic acid, bis(1-methylethyl) ester, isobornyl acetate (IBA, >94%), C8-C10 fatty acids methyl esters, triacetyl glycerine, and isoparaffinic hydrocarbon, or mixtures thereof.

Preferably, the oil carrier is selected from rape seed oil, methylated rape seed oil, synthetic paraffins (e.g. (C12-C16), (C14-C18), (C15-C21), and (C18-C26)), dipropylene glycol dibenzoate, hydrocarbons (e.g. C11-C14, n-alkanes, isoalkanes, cyclics, and <2% aromatics), aromatic hydrocarbons (e.g. C10-C13, and <1% naphthalene), aromatic hydrocarbons (e.g. C9, and benzene<0.1%), mixtures of petroleum extracts comprising solvent-dewaxed light paraffinic and solvent-dewaxed heavy paraffinic distillates, and isoparaffinic hydrocarbon, or mixtures thereof.

More preferably, the oil carrier is selected from rape seed oil, methylated rape seed oil, and mixtures of petroleum extracts comprising solvent-dewaxed light paraffinic and solvent-dewaxed heavy paraffinic distillates, or mixtures thereof.

In one embodiment, the oil carrier is selected from synthetic paraffins (e.g. (C12-C16), (C14-C18), (C15-C21), and (C18-C26)), dipropylene glycol dibenzoate, hydrocarbons (e.g. C11-C14, n-alkanes, isoalkanes, cyclics, and <2% aromatics), aromatic hydrocarbons (e.g. C10-C13, and <1% naphthalene), aromatic hydrocarbons (e.g. C9, and benzene<0.1%), mixtures of petroleum extracts comprising solvent-dewaxed light paraffinic and solvent-dewaxed heavy paraffinic distillates, and isoparaffinic hydrocarbon, or mixtures thereof.

Preferably, the oil carrier is a mixture of petroleum extracts comprising solvent-dewaxed light paraffinic and solvent-dewaxed heavy paraffinic distillates.

In a second aspect of the invention there is provided a method for inhibiting or controlling undesirable plant growth, wherein a herbicidally effective amount of the composition as described herein is applied to the plants or their habitat.

Crops of useful plants in which the compositions according to the invention can be used include especially cereals, in particular wheat, durum wheat, triticale, rye and barley. The term “crops” is to be understood as also including crops that have been rendered tolerant to herbicides or classes of herbicides (for example ALS, GS, EPSPS, PPO and HPPD inhibitors) as a result of conventional methods of breeding or genetic engineering. An example of a crop that has been rendered tolerant e.g., to imidoazolinones, such as imazamox, by conventional methods of breeding is Clearfield®) summer rape (Canola). Examples of crops that have been rendered tolerant to herbicides by genetic engineering methods include e.g. glyphosate- and glufosinate-resistant maize varieties commercially available under the trade names RoundupReady® and LibertyLink®. The weeds to be controlled may be both monocotyledonous and dicotyledonous weeds, such as, for example, Stellaria, Apera, Avena, Setaria, Sinapis, Lolium, Echinochloa, Bromus, Alopecurus, Phalaris, Amaranthus, Chenopodium, Convolvulus, Chrysanthemum, Papaver, Cirsium, Polygonum, Matricaria, Galium, Viola and Veronica.

Crops are also to be understood as being those which have been rendered resistant to harmful insects by genetic engineering methods, for example Bt maize (resistant to European corn borer), Bt cotton (resistant to cotton boll weevil) and also Bt potatoes (resistant to Colorado beetle). Examples of Bt maize are the Bt-176 maize hybrids of NK® (Syngenta Seeds). The Bt toxin is a protein that is formed naturally by Bacillus thuringiensis soil bacteria. Examples of toxins and transgenic plants able to synthesise such toxins are described in EP-A-451 878, EP-A-374 753, WO 93/07278, WO 95/34656, WO 03/052073 and EP-A-427 529. Examples of transgenic plants that contain one or more genes which code for an insecticidal resistance and express one or more toxins are KnockOut® (maize), Yield Gard® (maize), NuCOTIN33BC (cotton), Bollgard® (cotton), NewLeaf® (potatoes), NatureGard® and Protexcta®. Plant crops and their seed material can be resistant to herbicides and at the same time also to insect feeding (“stacked” transgenic events). Seed can, for example, have the ability to express an insecticidally active Cry3 protein and at the same time be glyphosate-tolerant. The term “crops” is to be understood as also including crops obtained as a result of conventional methods of breeding or genetic engineering which contain so-called output traits (e.g. improved flavour, storage stability, nutritional content).

Areas under cultivation are to be understood as including land where the crop plants are already growing as well as land intended for the cultivation of those crop plants.

In a third aspect of the invention there is provided a method of preparing a composition as described herein.

Unless otherwise stated are percentages are given as percentages by total weight and all embodiments and preferred features may be combined in any combination.

The invention is demonstrated by the following non-limiting Examples.

### EXAMPLES

### Emulsion Concentrates (EC)

An EC composition according to the invention was prepared and compared to both a composition containing TEHP and a composition without an adjuvant. The components are set out in Table 1.

TABLE 1

| | Composition | | |
|---|---|---|---|
| | 1 (Arlamol | Composition | Composition |
| Amount [% w/v] | PS15E) | 2 (TEHP) | 3 (None) |
| Pinoxaden | 5 | 5 | 5 |
| Safener | 3.45 | 3.45 | 3.45 |
| Emulsifier (copolymer) | 5 | 5 | 5 |
| Emulsifier (ethoxylate | 2 | 2 | 2 |
| condensation product) | | | |
| Emulsifier (oxirane-based | 3 | 3 | 3 |
| polymer) | | | |
| Thickener | 2.5 | 2.5 | 2.5 |
| ARLAMOL PS15E | 25 | — | — |
| (polypropylene glycol | | | |
| stearyl ether) | | | |
| TEHP | — | 25 | — |
| Glycol solvent | 19 | 19 | 19 |
| Solvent (mixture of heavy | Filler | Filler | Filler |
| aromatic hydrocarbons) | | | |

### Stability Testing

The compositions were stored for 2 at elevated temperatures after which the Al loss was determined. The Al loss was calculated in comparison to a reference sample that was stored the same period at a temperature of −18° C. and is given in %. The Al content was determined by using a Gas chromatography (GC) method (Agilent 7890A).

TABLE 2

| Decomposition (%) at 54° C. | Comp. 1 | Comp. 2 | Comp. 3 |
|---|---|---|---|
| Degradation of Pinoxaden | 2.85% | 4.53% | 2.45% |

It can be seen that the composition according to the invention exhibit improved stability compared to TEHP-containing composition.

### Efficacy

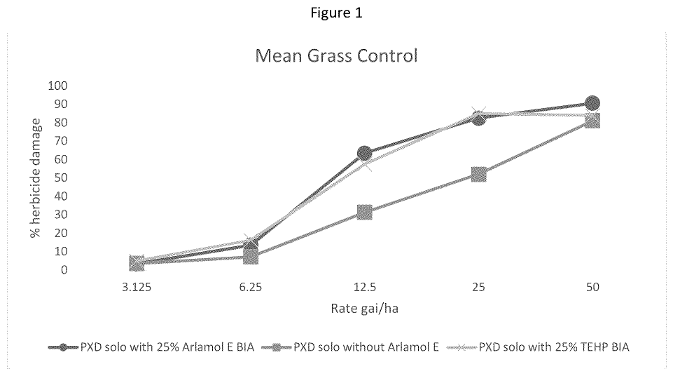

The test plants Triticum aestivum, Hordeum vulgare, Echinochloa crus-galli, Avena fatua, Lolium multifiorum, Panicum miliaceum, Phalais paradoxa, and Alopecurus myosuroides were sprayed with the compositions below. The results were obtained by visual assessments 14 days after application with the mean average of the results being set out in Table 3 and shown in FIG. 1.

TABLE 3

| Composition | rate gai/ha | Mean Grass Control |
|---|---|---|
| Composition 1 | 3.125 | 3 |
| | 6.25 | 13 |
| | 12.5 | 63 |
| | 25 | 82 |
| | 50 | 90 |
| Composition 3 | 3.125 | 4 |
| | 6.25 | 7 |
| | 12.5 | 31 |
| | 25 | 52 |
| | 50 | 81 |
| Composition 2 | 3.125 | 5 |
| | 6.25 | 16 |
| | 12.5 | 58 |
| | 25 | 85 |
| | 50 | 84 |

It can be seen that the compositions of the invention demonstrate comparable performance to the use of TEHP.

The invention is defined by the claims.

1. A liquid herbicidal composition comprising pinoxaden and an adjuvant; wherein the adjuvant is a built-in oil-type adjuvant.

2. The composition according to claim 1, wherein the built-in oil-type adjuvant is a polypropylene glycol ether.

3. The composition according to claim 1, wherein the polypropylene glycol ether is a polypropylene glycol stearyl ether.

4. The composition according to claim 1, wherein the polypropylene glycol stearyl ether has the formula:
R—(O—CH₂CH(CH₃))n-O—R1
wherein R is a C12 to C18 straight- or branched-chain alkyl or alkenyl group, n is from 1 to 30, and R1 is H or methyl.

5. The composition according to claim 4, wherein n is from 5 to 18.

6. The composition according to claim 4, wherein R is a C₁₆ to C₁₈ straight- or branched-chain alkyl.

7. The composition according to claim 1, wherein the built-in oil-type adjuvant is present in an amount of from 10 to 40% by weight.

8. The composition according to claim 1, wherein the pinoxaden is present in an amount of from 1 to 10% by weight.

9. The composition according to claim 1, further comprising a safener.

10. The composition according to claim 1, wherein the composition comprises substantially no tris(2-ethylhexyl) phosphate (TEHP).

11. The composition according to claim 1, which is in the form of an Emulsion Concentrate (EC) or an oil dispersion (OD).

12. A method for inhibiting or controlling undesirable plant growth, wherein a herbicidally effective amount of the composition according to claim 1 is applied to the plants or their habitat.

13. A method of preparing a herbicidal composition comprising combining pinoxaden and an adjuvant; wherein the adjuvant is a built-in oil-type adjuvant comprising polypropylene glycol ether.

14. The composition of claim 9, wherein the safener includes cloquintocet-mexyl or mefenpyr-diethyl.
